(19) United States
(12) Patent Application Publication
(10) Pub. No.: US 2011/0202869 A1
(43) Pub. Date: Aug. 18, 2011

(54) METHOD FOR SEARCHING ITEMS

(75) Inventor: Kyong-hoon Sung, Seoul (KR)

(73) Assignee: Valups Corporation, Seoul (KR)

(21) Appl. No.: 12/920,008

(22) PCT Filed: Feb. 28, 2008
(86) PCT No.: PCT/KR09/00885

§ 371 Date: Nov. 22, 2010

(30) Foreign Application Priority Data
Feb. 28, 2008 (KR) 10-2008-0018471

(51) Int. Cl. G06F 3/048

(52) U.S. Cl. 715/784

(57) ABSTRACT

Provided is a method for displaying a plurality of items on a screen and searching an item from the plurality of items. The item searching method includes: displaying a plurality of items that are selectable on a screen; and searching and designating an item from the plurality of items by moving a cursor according to a key input, while accelerating the cursor's movement according to a duration time for which the key continues to be pressed. Accordingly, it is possible to search items at high speed.

### CROSS-REFERENCE TO RELATED APPLICATIONS

This application is the National Stage of International Application No. PCT/KR2009/000885, filed Feb. 25, 2009, and claims priority from and the benefit of Korean Patent Application No. 10-2008-0018471, filed on Feb. 22, 2008, which are both hereby incorporated by reference for all purposes as if fully set forth herein.

### BACKGROUND OF THE INVENTION

1. Field of the Invention

The present invention relates to a user interface, and more particularly, to a technology for displaying a plurality of items on a screen and searching an item from the plurality of items through an input device, such as a remote controller, a keyboard, etc.

2. Discussion of the Background

If a plurality of items are displayed on one screen and an item is selected from the plurality of items, additional information related to the selected item is provided. Here, a user can select a desired item from among the plurality of items by manipulating an input device such as a remote controller or keyboard. In the case where too many items have to be displayed on a screen, well-known scroll search can be used to allow a user to search all items on the limited screen size.

### SUMMARY OF THE INVENTION

Accordingly, the present invention provides an improved item searching method.

According to an exemplary aspect of the present invention, there is provided a method for searching items, including: displaying a plurality of items that are selectable on a screen; and searching and designating an item from the plurality of items by moving a cursor according to a key input, while accelerating the cursor's movement according to a duration time for which the key continues to be pressed.

The method further includes if the key input is stopped, terminating the cursor's movement while decelerating the cursor's movement considering a final speed which the cursor reaches, thereby terminating the searching of the item.

Therefore, in the item searching method according to the present invention, items can be searched at high speed by gradually accelerating a cursor's movement according to a duration time for which a key continues to be pressed. For example, if a direction key continues to be pressed, it is determined that a user wants to move a current cursor quickly in the corresponding direction and accordingly the cursor's movement is gradually accelerated so that the cursor can reach a desired item quickly. Also, by tuning the acceleration speed to an appropriate speed at which the user does not feel inconvenient in viewing the corresponding screen, a user-friendly environment can be provided. Furthermore, by displaying only a part of additional information on the screen, smooth acceleration processing is possible.

Also, by gradually decelerating the cursor's movement and then stopping the cursor's movement upon termination of the item searching, the user can feel convenient. If the key is again pressed upon the deceleration, the cursor's movement is reaccelerated. Therefore, the user can adjust the speed at which the cursor moves by combining decelerations and reaccelerations appropriately.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart of a method for searching items, according to an embodiment of the present invention.

FIG. 2 is a block diagram of an apparatus in which the item searching method of FIG. 1 is performed, according to an embodiment.

FIG. 3 shows an example in which the item searching method of FIG. 1 is implemented.

FIG. 4 shows another example in which the item searching method of FIG. 1 is implemented.

### DETAILED DESCRIPTION OF THE ILLUSTRATED EMBODIMENTS

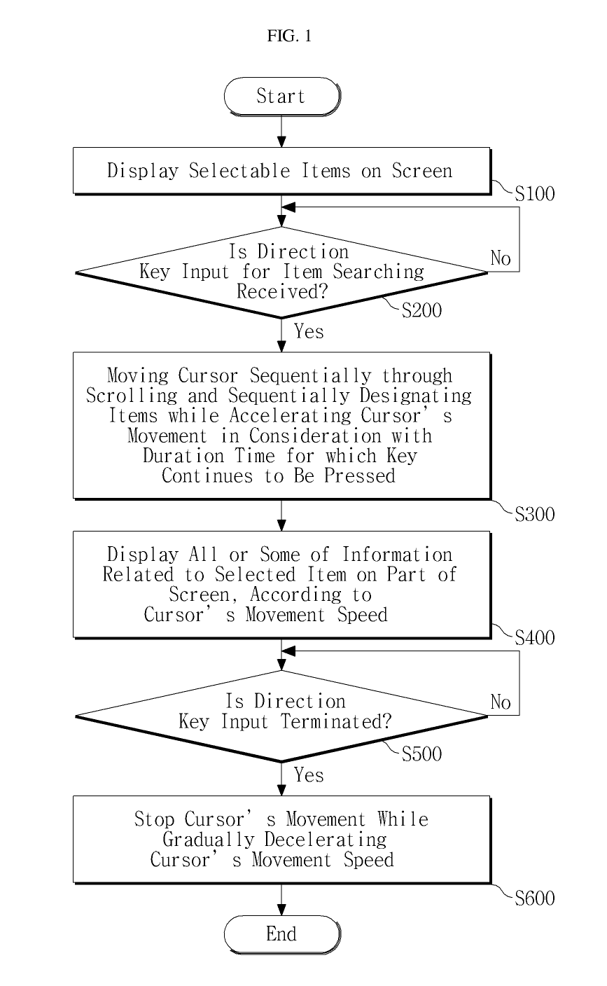

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numbers in the drawings denote like elements. FIG. 1 is a flowchart of a method for searching items, according to an embodiment of the present invention.

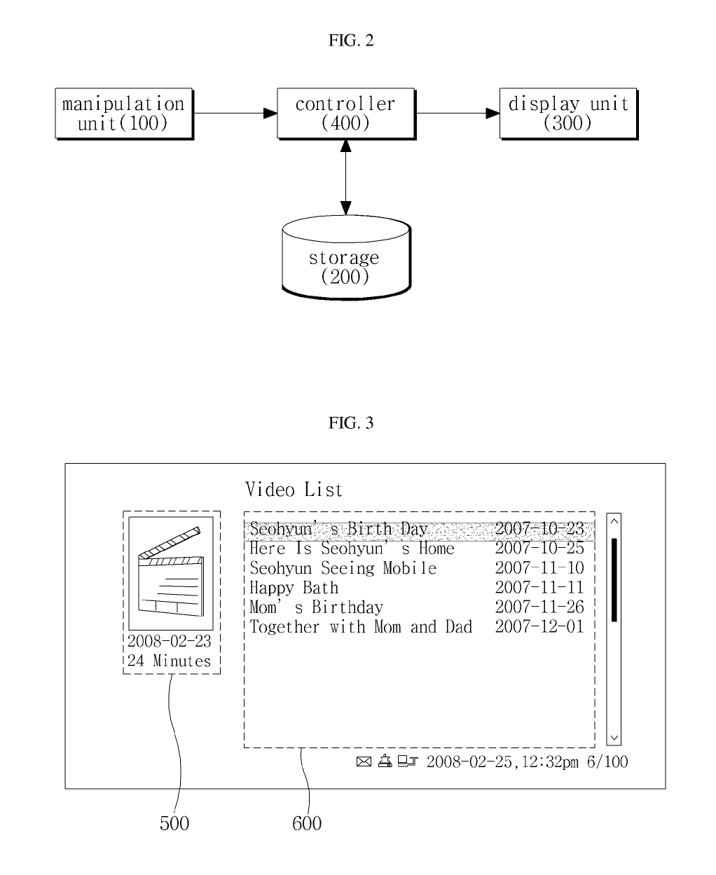

The item searching method can be performed by an apparatus for displaying a plurality of items and allowing selection of an item from among the plurality of items. The apparatus may be a set-top box, mobile phone, Personal Digital Assistant (PDA), notebook, desktop computer, etc., but the present invention is not limited to these. An exemplary apparatus is illustrated in FIG. 2. In FIG. 2, a manipulation unit 100 is a device for receiving user inputs and may be a remote controller or keyboard. A storage 200 stores control program data for controlling the entire operations of the apparatus, item data and additional information related to each item. A display unit 300 may be a Liquid Crystal Display (LCD), and displays the data items and additional information stored in the storage 200. A controller 400 controls the entire operations of the apparatus based on the control program data, reads data stored in the storage 200 in response to a manipulation command from the manipulation unit 100, and outputs the data to the display unit 300 to display it on a screen.

Now, the item searching method which is performed by the apparatus will be described in detail with reference to FIGS. 1 and 2. First, the controller 400 displays items that can be selected by a user on a screen (operation S100). For example, if the user requests a list of motion pictures stored in the storage 200 by manipulating the manipulation unit 100, the controller 400 reads the list of motion pictures stored in the storage 200 and displays the list on the screen in response to a manipulation command from the manipulation unit 100. If the size of the list is too large to be displayed on one screen, a part of the list is displayed on the screen and the remaining part can be displayed on the screen through scrolling. In this case, as illustrated in FIG. 3, a scroll bar is provided in the right portion of the screen to allow searching of items of the remaining part. Also, it is possible to allow the user to recognize the range of currently displayed items through the position of the scroll bar.

Also, it is possible to designate a desired item by moving the cursor through manipulation of a direction key, etc. In FIG. 3, a current cursor designates “Seohyun's Birth Day” which is the top item of items displayed on a screen. Also, the left portion of the screen shows additional information related to the designated item. For example, the additional information related to the designated item is an image and text information related to the designated item. In the example of FIG. 3, a representative image and text information (filming date and playback time) of the designated item “Seohyun's Birth Day” are displayed on the left portion of the screen.

If it is determined in operation S200 that a cursor movement command is received in accordance with the user's manipulation of a direction key, the controller 400 moves the current cursor to a next item. If the user continues to press the direction key, the controller 400 continues to sequentially move the cursor to the following items while gradually accelerating the cursor's movement considering the duration time for which the key continues to be pressed (operation S300). That is, the controller 400 increases the speed at which the cursor moves, depending on the duration time for which the key continues to be pressed. Then, the controller 400 checks an item designated by the cursor, reads data matched to the item from the storage 200, and displays the data on a part of the screen like a reference number 500 of FIG. 3.

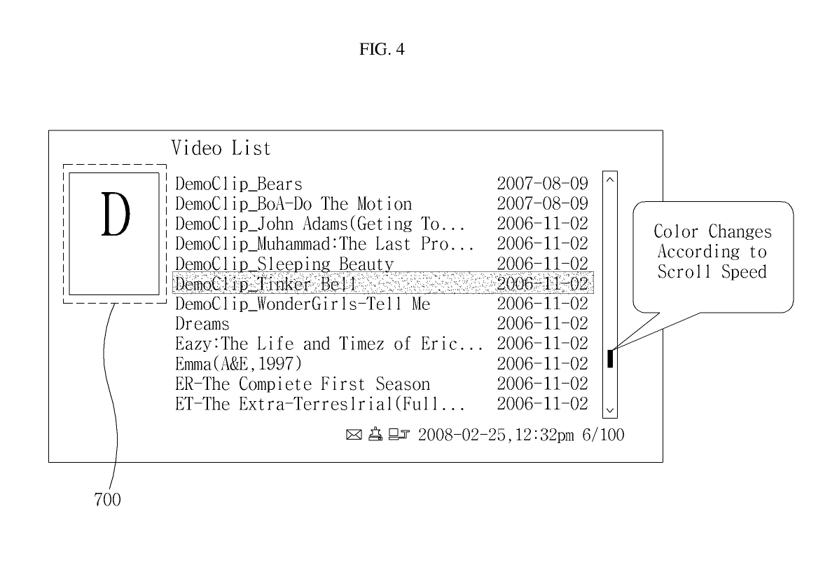

Also, according to an aspect, if the cursor's movement speed exceeds a predetermined value, in other words, if the duration time for which the key is pressed exceeds a predetermined value, the controller 400 displays only brief information related to the designated item on the part of the screen (operation S400). The brief information is, for example, alphabet “D” without any image, as shown by a reference 700 in FIG. 4. The brief information is the first letter of the text of the currently designated item, and only provides a hint for the location of the currently designated item. By displaying the first letter of the currently designated item if the items of the list are arranged alphabetically and displaying the year or month on which the currently designated item has been made if the items of the list are arranged in the order of dates, it is possible to roughly represent the location of the currently displayed part on the entire list. This helps smooth acceleration processing. Because if additional information related to a currently designated item includes an image like the reference number 500 in FIG. 3, the speed at which the image is decoded or all related information is extracted and displayed on a screen does not catch up with the speed at which the cursor moves.

If the direction key is no longer pressed (operation 500), the controller 400 stops moving the cursor, thus terminating item searching. The controller 400 may stop moving the cursor in a manner to gradually decelerate the cursor's movement speed (operation S600). Here, by adjusting the time for which the cursor's movement is decelerated, more various effects can be obtained. For example, by shortening the deceleration time, the user may have a feeling like the cursor stops instantly, and by lengthening the deceleration time, the user may have a feeling like he or she actually lifts up a heavy object and turns it around.

Meanwhile, as shown in FIG. 4, it is possible to make the user intuitively sense a change in scroll speed by changing the color of the scroll bar according to the scroll speed.

1. A method for searching items, comprising:
displaying a plurality of items that are selectable on a screen; and
searching and designating an item from the plurality of items by moving a cursor according to a key input, while accelerating the cursor's movement according to a duration time for which the key continues to be pressed.

2. The method of claim 1, further comprising if the key input is stopped, terminating the cursor's movement while decelerating the cursor's movement considering a final speed which the cursor reaches, thereby terminating the searching of the item.

3. The method of claim 2, further comprising displaying all or some of additional information related to the designated item on a part of the screen, according to a speed at which the cursor moves.
